(19) United States
(12) Patent Application Publication
(10) Pub. No.: US 2022/0098787 A1
(43) Pub. Date: Mar. 31, 2022

(54) Dryer Lint Tube

(71) Applicants: Laura Kiker, Florence, TX (US); Lisa Kellar, Reserve, NM (US)

(72) Inventors: Laura Kiker, Florence, TX (US); Lisa Kellar, Reserve, NM (US)

(21) Appl. No.: 17/482,508

(22) Filed: Sep. 23, 2021

Related U.S. Application Data
(60) Provisional application No. 63/083,400, filed on Sep. 25, 2020.

(51) Int. Cl. D06F 58/22; F16L 3/12; F16L 11/11

(52) U.S. Cl. CPC D06F 58/22; F16L 11/11; F16L 3/1215

(57) ABSTRACT

The present invention relates to a dryer lint tube/hose made up of a flexible and heat-resistant material. The dryer lint tube comes in various accordion-style designs that allow the tube to be flexible, adjustable and extendable in length. In one design, the tube has detachable tubular ends for securely fitting the tube to a dryer vent and a wall vent. Further, in another embodiment, the tube has alternate tubular and accordion-style lengths. In a third embodiment, the tube has a pure accordion-style design. The dryer lint tube is easy to cut, and can be installed without any tools. A twist-on clamp with a large end is used to secure the tube at both the dryer vent and the wall vent.

### CROSS-REFERENCE TO RELATED APPLICATION

The present application claims priority to, and the benefit of, U.S. Provisional Application No. 63/083,400, which was filed on Sep. 25, 2020 and is incorporated herein by reference in its entirety.

### FIELD OF THE INVENTION

The present invention relates generally to the field of dryer exhaust pipes. More specifically, the present invention relates to an improved accordion-style silicon dryer lint tube/hose that is customizable and easy to install with any conventional dryer vent and wall vent. The dryer lint tube comes in various accordion-style designs that allow the tube to be flexible, adjustable and extendable in length. The tube can have detachable tubular ends for a secure fit onto a dryer vent and a wall vent and alternatively, the tube can have alternate tubular and accordion-style lengths. The dryer lint tube is easy to cut and can be installed without any tools. A twist on clamp with a large end is used to secure the tube at both the dryer vent and the wall vent. Accordingly, the present disclosure makes specific reference thereto. Nonetheless, it is to be appreciated that aspects of the present invention are also equally applicable to other like applications, devices and methods of manufacture.

### BACKGROUND

By way of background, when a clothes dryer is installed in a building, it must be vented to the outside. Clothes dryers are typically vented through an exterior wall of a home. Usually, a flexible dryer exhaust pipe or tube is installed to vent out moisture, lint and other debris. During installation, the dryer exhaust tube is attached to the outlet of the dryer when the dryer is away from a wall. However, after installation, as the dryer is moved closer to the wall, the flexible tube can tear or kink. Similarly, during installation of the tube, the aluminum end of the presently available lint/dryer tube does not typically slide onto the dryer or wall vent very easily, and ends up tearing or kinking.

The kinks in the dryer vent hose/tube result in numerous fires hazards every year. Kinks in the dryer vent hose can also cause clogging and accumulation of lint that can reduce dryer efficiency. In gas dryers, that restriction can cause dangerous exhaust gases to be emitted into the building in which the clothes dryer is installed.

Currently available hoses/tubes are made up of aluminum that is hard to cut at home and requires professional help. Further, these hoses are not easily extendable or retractable. Expensive tools and manual labor are required for users to customize these hoses. The aluminum hoses also cause lint to escape at the connections at both the dryer vent and the wall vent due to a loose fit. This causes debris to enter a house, and can also cause a fire in the house.

Therefore, there exists a long felt need in the art for an improved dryer lint tube that eliminates or reduces kinks and tearing during and after installation. There is also a long felt need in the art for an improved dryer lint tube that eliminates the clogging of lint and debris. Additionally, there is a long felt need in the art for an improved dryer lint tube that eliminates the chances of fire due to an accumulation of lint and debris in the tube. Moreover, there is a long felt need in the art for an improved dryer lint tube that is cost-effective, flexible and customizable. Further, there is a long felt need in the art for an improved dryer lint tube that can be installed without using any professional help, and without use of expensive tools. Furthermore, there is a long felt need in the art for an improved dryer lint tube that securely fits onto both the wall vent and the dryer vent. Finally, there is a long felt need in the art for an improved dryer lint tube that enables a user to easily and safely customize the hose as per his or her needs and/or wants to vent out outside the home.

The subject matter disclosed and claimed herein, in one embodiment thereof, comprises a flexible dryer lint tube device designed to prevent lint from escaping at the tube connection with a dryer vent/pipe and a wall vent. The flexible dryer lint tube device comprises an accordion-style dryer lint tube, that is designed as a flexible and extendable tube for connecting the dryer exhaust pipe/vent and the wall vent and a pair of twist-on clamps with a large end for securing the tube to the dryer exhaust pipe/vent and the wall vent. Typically, the dryer lint tube is made up of silicon and is heat-resistant. The dryer lint tube has a first end that securely fits/connects onto the dryer exhaust pipe/vent, and a second end that securely fits/connects onto the wall vent thereby not allowing lint to escape at the said connections. The dryer lint tube has a portion of accordion-style lengths and a portion of tubular-style lengths, thereby allowing the dryer lint tube to hold its form during use.

In this manner, the flexible dryer lint tube device accomplishes all of the forgoing objectives, and provides a relatively safe, cost-effective, customizable and flexible dryer hose which safely connects the dryer to the wall vent. The dryer hose allows users to customize the tubing to suit their needs, including length and angle, and provides a snug fit. The dryer hose does not allow lint to escape and can be installed easily without use of tools. The heat-resistant material and the elimination of kinks of the dryer hose prevent fire hazards due to accumulation of lint in and near the tube.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flexible dryer lint tube device. The dryer lint tube device is designed to prevent lint from escaping at the tube connection with a dryer vent/pipe and a wall vent. More specifically, the device comprises an accordion-style dryer lint tube that is designed as a flexible and extendable tube for connecting the dryer exhaust pipe/vent and the wall vent, and a pair of twist on clamps with a large end for securing the tube to the dryer exhaust pipe/vent and the wall vent. Typically, the tube is made up of silicon and is heat-resistant. The tube has a first end that securely fits/connects onto the dryer exhaust pipe/vent, and a second end that securely fits/connects onto the wall vent thereby preventing lint from escaping at the said connections. The tube has a portion of accordion-style lengths and a portion of tubular-style lengths, thereby allowing the tube to hold its form during use. In yet another embodiment of the present invention, the accordion-style lengths and the tubular-style lengths are positioned alternately to each other, and allow the tube to be flexible and extendable.

In yet another embodiment of the present invention, an accordion-style dryer tube is disclosed. The dryer tube is designed to connect a dryer outlet vent to a wall vent. The accordion-style tube is made up of a flexible and heat-resistant material like silicon, and has tubular opposing ends. The accordion length allows the tube to be extended or retracted, and the opposing tubular ends form a secure fit with a dryer exhaust pipe/vent and a wall vent for exhausting lint and moisture from the dryer. The secure fit at both the dryer exhaust pipe/vent and the wall vent prevents lint from escaping.

In yet another embodiment of the present invention, the tubular ends can be integrated to the accordion tube, or can be detachably-secured at the ends of the accordion tube. In still yet another embodiment, the tubular ends fit by being inserted into the dryer exhaust pipe/vent and the wall vent, and can be further secured by using a twist-on clamp with a large end, wherein the large end is turned to secure the clamp around the tubular ends.

In yet another embodiment of the present invention, a method for connecting a dryer exhaust pipe/vent to a wall vent using a dryer exhaust tube is described. The method includes initially selecting a desired length of an accordion-style tube having accordion-style and tubular-style lengths; securely fitting a first end of the accordion-style tube onto the dryer exhaust pipe/vent, and securely fitting a second end of the accordion-style tube onto the wall vent, thereby connecting the dryer exhaust pipe/vent and the wall vent. The method also includes using one twist-on clamp at both the first end and the second end, to securely fit the tube onto the dryer exhaust pipe/vent and wall vent, thereby preventing lint and debris from escaping.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the dryer lint tube device of the present invention, wherein the device has alternate tubular and accordion-style lengths in accordance with the disclosed architecture;

FIG. 2 illustrates a perspective view of another potential embodiment of the dryer lint tube device of the present invention, wherein the device has detachable tubular ends in accordance with the disclosed architecture;

FIG. 3 illustrates a perspective view of a third potential embodiment of the dryer lint tube device of the present invention, wherein an accordion-style tube is disclosed in accordance with the disclosed architecture;

FIG. 4 illustrates a perspective view showing one potential embodiment of the dryer lint tube device, wherein the device has alternate tubular and accordion-style lengths, and is being used for connecting a dryer to a wall vent in accordance with the disclosed architecture;

FIG. 5 illustrates a perspective view showing another potential embodiment of the dryer lint tube device, wherein the device has detachable tubular ends and is being used for connecting the dryer to a wall vent in accordance with the disclosed architecture;

FIG. 6 illustrates a perspective view showing another potential embodiment of the dryer lint tube device, wherein an accordion-style tube is being used for connecting the dryer to a wall vent in accordance with the disclosed architecture; and

FIG. 7 illustrates a perspective view of the hose clamp used for securing one potential embodiment of the dryer lint tube of the present invention to a wall vent and dryer vent in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved dryer lint tube that eliminates or reduces kinks and tearing during and after installation. There is also a long felt need in the art for an improved dryer lint tube that eliminates the clogging of lint and debris. Additionally, there is a long felt need in the art for an improved dryer lint tube that eliminates the chances of fire due to the accumulation of lint and debris in the tube. Moreover, there is a long felt need in the art for an improved dryer lint tube that is cost-effective, flexible and customizable. Further, there is a long felt need in the art for an improved dryer lint tube that can be installed without using any professional help, and without use of expensive tools. Furthermore, there is a long felt need in the art for an improved dryer lint tube that securely fits onto both the wall vent and the dryer vent. Finally, there is a long felt need in the art for an improved dryer lint tube that enables a user to easily and safely customize the hose as per his or her needs and/or wants to vent outside the home.

The present invention, in one exemplary embodiment, is a novel accordion-style dryer tube. The dryer tube is designed to connect a dryer outlet vent to a wall vent. The accordion-style tube is made up of a flexible and heat-resistant material like silicon, and has tubular opposing ends. The accordion length allows the tube to be extended or retracted, and the opposing tubular ends form a secure fit with a dryer exhaust pipe/vent and a wall vent for exhausting lint and moisture from the dryer. The secure fit at both the dryer exhaust pipe/vent and the wall vent prevents lint from escaping.

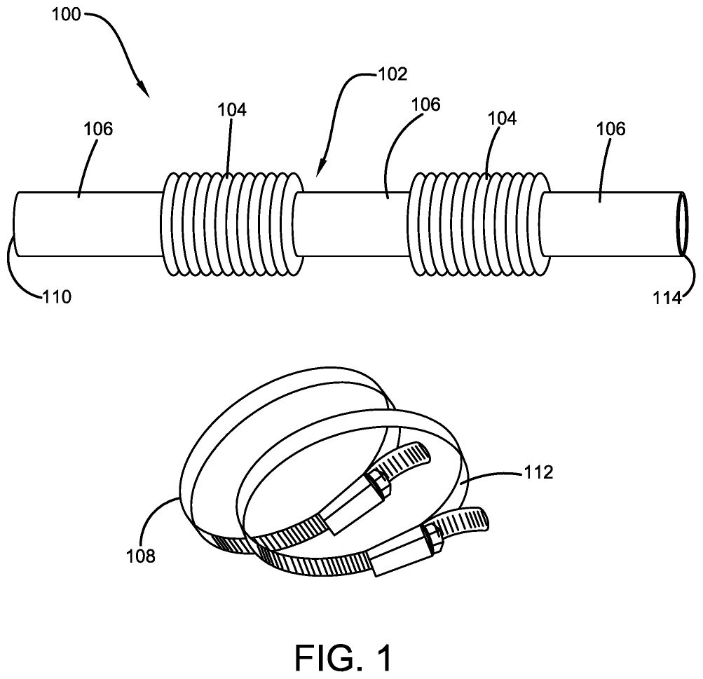

Referring initially to the drawings, FIG. 1 illustrates a perspective view of one embodiment of the dryer lint tube device of the present invention. The dryer lint tube device 100 of the present embodiment is an extendable and flexible tube that connects a dryer exhaust pipe to a wall pipe. More specifically, the dryer lint tube device 100 of the present embodiment has an accordion-style silicon tube 102 having alternate lengths of accordion-style 104 and tubular-style 106. The device 100 further comprises a pair of hose clamps 108, 112 wherein a first hose clamp 108 securely clamps a first end 110 of the tube 102 to an opening of the dryer exhaust pipe/vent, and a second clamp 112 securely clamps a second end 114 of the tube 102 to the wall pipe. It should be noted that both the first end 110 and the second end 114 can be either tubular-style 106 or accordion-style 104. The accordion lengths 104 make the tube flexible and customizable to accommodate the needs and/or wants of a user by, allowing the tube 102 to turn and extend in different directions and/or angles. The silicon tube 102 can be cut to different lengths as per the distance between the dryer exhaust pipe and the wall pipe.

The accordion-style of the tube 102 allows the angle of the tube 102 to be adjusted to fit even small spaces. The tube 102 allows the smooth flow of lint from the dryer to the wall pipe without any lint escaping or becoming clogged. Also, the first end 110 and the second end 114 form a secure fit to the dryer pipe and the wall pipe respectively, thus preventing lint from escaping. Further, the clamps 108, 112 secure and tighten, providing additional security against lint escaping. Advantageously, the silicon tube 102 eliminates the chances of a fire from dryer lint or other debris building up in the tube 102. Additionally, the silicon tube 102 is easy to use with a fire extinguisher, and can easily be removed without the use of a tool or without help from a professional.

Further, the silicon tube 102 is easy to clean from both the exterior and the interior. The tube 102 can be pulled easily from the pipes, thereby allowing a user to easily remove the debris and lint. The silicon material of the tube 102 does not allow easy tearing, which provides a long life to the silicon dryer lint tube 102 of the present embodiment.

Preferably, each accordion-style length 104 is approximately in the range of 1′-2′ and each tubular length 106 is approximately in the range of 2′-3′. However, it should be appreciated that these lengths can be adjusted and customized as per a user's wants and/or needs.

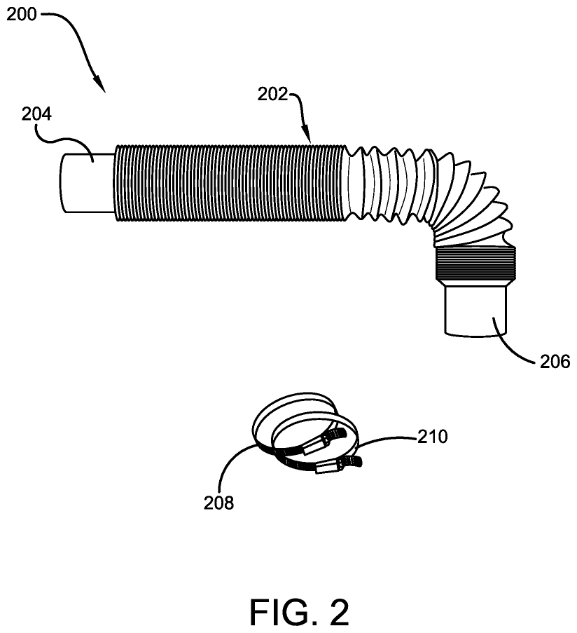

FIG. 2 illustrates a perspective view of another embodiment of the dryer lint tube device of the present invention. The dryer lint tube device 200 of the present embodiment comprises an accordion-style silicon tube 202 having tubular-style ends 204, 206. The first tubular-style end 204 and the second tubular-style end 206 are designed to securely fit onto the dryer pipe and wall pipe respectively. The accordion length 202 provides flexibility in both length and turning along the complete length of the tube 202, however the tubular ends 204, 206 provide a secure fit which prevents lint from escaping from the vents and pipe. The tube 202 can be formed of a flexible and heat-resistant material such as silicon, etc., or any other suitable material as is known in the art, and can be available in different lengths, depending on the needs and/or wants of a user.

The system 200 further comprises a pair of hose clamps 208, 210, wherein a first hose clamp 208 securely clamps the first tubular style end 204 to an opening of the dryer exhaust pipe, and a second clamp 210 securely clamps the second tubular style end 206 to the wall pipe. The tubular ends 204, 206 can be integrated to the tube 202 or can also be detachably-secured, thereby allowing users to use either one or both tubular ends as per their requirements.

Preferably, each tubular end 204, 206 is approximately in the range of 3″-4″ for a secure fit. However, it should be appreciated that the length of the tubular ends 204, 206 can be adjusted and customized as per a user's wants and/or needs.

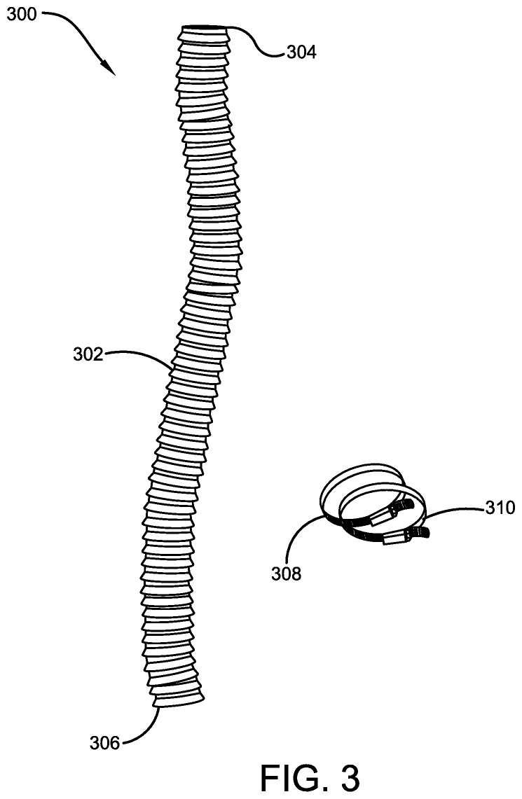

FIG. 3 illustrates a perspective view of a third embodiment of the dryer lint tube device of the present invention. The dryer lint tube device 300 of the present embodiment has an accordion-style silicon tube 302 without any tubular lengths or ends. The accordion tube 302 has opposing ends 304, 306 that are used to securely fit the tube 302 to the wall pipe and dryer pipe respectively. The accordion tube 302 provides flexibility in both length and turning, and provides a secure fit to eliminate any lint from escaping from the vents and pipe. The tube 302 can be formed of a flexible and heat-resistant material such as silicon, or any other suitable material as is known in the art and can be available in different lengths.

The device 300 further comprises a pair of hose clamps 308, 310 wherein a first clamp 308 securely clamps the first end 304 to an opening of the dryer exhaust pipe, and a second clamp 310 securely clamps the second end 306 to the wall pipe.

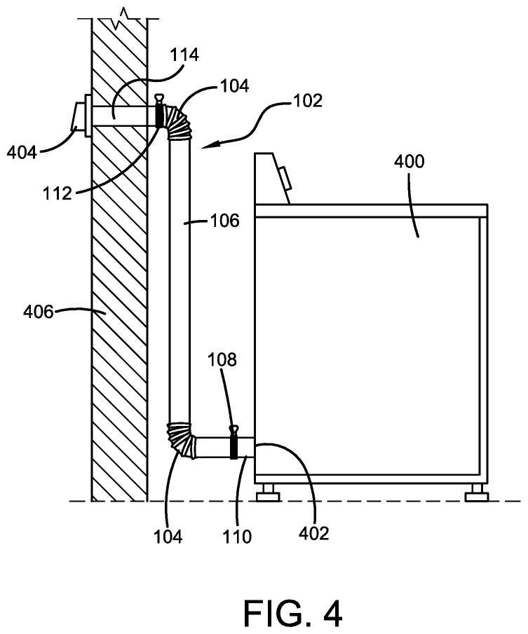

FIG. 4 illustrates a perspective view showing one embodiment of the dryer lint tube device of the present invention in use. As shown, the dryer 400 has a dryer pipe/vent 402 from which the warm air along with lint and other debris is exhausted by the dryer 400. The first end 110 of the dryer lint tube 102 securely fits onto the dryer vent 402 and is secured by the first clamp 108, and the second end 114 of the tube 102 securely fits onto the wall vent 404 disposed in an external wall 406 and is secured by the second clamp 112. The accordion-style lengths 104 allow the tube 102 to be flexible and adjust for turns and angles. The tubular-style lengths 106 allow the secure and smooth flow of debris and lint within the tube 102. The dryer lint tube 102 can be used to connect the dryer 400 with the wall vent 404 in situations where the external wall 406 is near the dryer 400, and in situations where the distance between the dryer 400 and the external wall 406 is large.

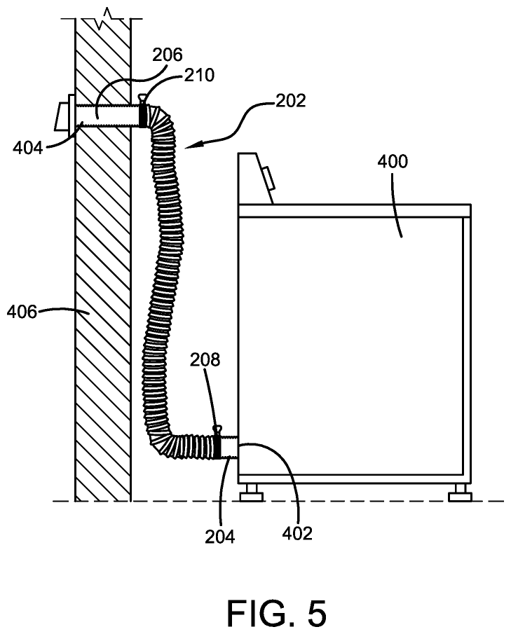

FIG. 5 illustrates a perspective view showing another embodiment of the dryer lint tube device of the present invention in use. The first tubular end 204 of the dryer lint tube 202 securely fits onto the dryer vent 402 and is secured by a first clamp 208, and the second tubular end 206 of the tube 202 securely fits onto the wall vent 404 disposed in the external wall 406 and is secured by the second clamp 210. The accordion-style tube 202 allows the tube to be extended, retracted or adjusted in direction and turn as per a user's wants and/or needs, and the space available between the dryer vent 402 of the dryer 400 and the wall vent 404.

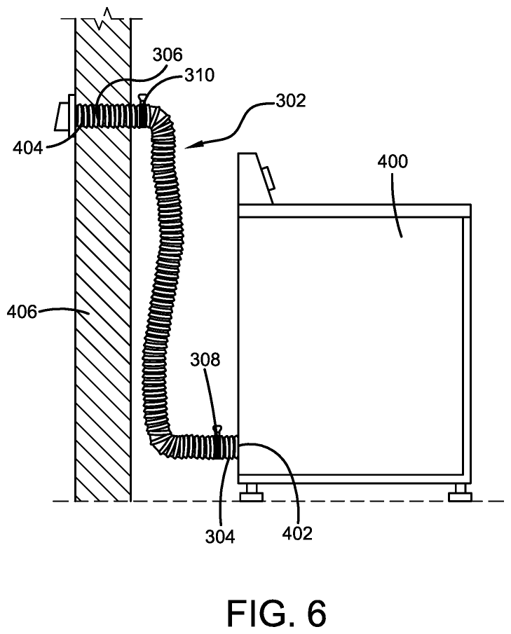

FIG. 6 illustrates a perspective view showing a third embodiment of the dryer lint tube device of the present invention in use. The first end 304 of the dryer lint tube 302 securely fits onto the dryer vent 402 and is secured by a first clamp 308, and the second end 306 of the tube 302 securely fits onto the wall vent 404 disposed in the external wall 406 and is secured by the second clamp 310. The accordion-style tube 302 allows the tube to be extended, retracted or adjusted in direction and turn as per a user's needs and/or wants, and the space available between the dryer vent 402 of the dryer 400 and the wall vent 404.

It should be appreciated that the dryer lint tube device of various embodiments of the present invention can come in various colors, designs and sizes to meet a user's wants and/or needs. Further, the dryer lint tube device is soft, pliable, adjustable and flexible, thereby preventing lint from escaping from the connections at both the dryer vent and the wall vent. The dryer lint tube device can be used regardless of where in the room or outside the exhaust pipe is located. Further, the dryer lint tube device of various embodiments provides a quick connect and disconnect assembly that can be used with substantially any conventional dryer.

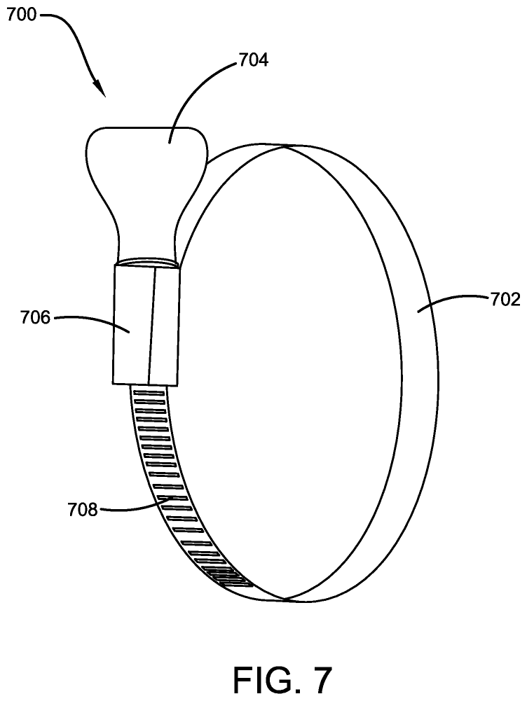

FIG. 7 illustrates a perspective view showing the hose clamp used for securing the dryer lint tube device to a wall vent and dryer vent. The hose clamp 700 can be manufactured from a combination of steel or iron, stainless steel, galvanized steel, etc., or any other suitable material as is known in the art. The hose clamp 700 can also be made of anhydrous ammonia that is typically cadmium-plated to prevent rust and corrosion. The hose clamp 700 typically has a round, flat, thin single-gear band 702. The band 702 is configured in a circular shape for securing around the ends of the dryer lint tube device. The diameter of the band 702 increases or decreases as a large end component 704 rotates in a clockwise or in a counter-clockwise direction, within a screw gauge 706. Further, the band 702 includes a plurality of slots 708 that are configured to interact with the screw gauge or clamping device 706 to tighten or loosen the hose clamp 700.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dryer lint tube device”, “device”, “dryer tube device”, and “clothes dryer vent coupling device”, are interchangeable and refer to the dryer lint tube device 100, 200, 300 of the present invention. Similarly, as used herein “dryer lint tube”, “dryer tube”, “accordion tube”, “tube” and “accordion-style silicon tube” are interchangeable and refer to the dryer lint tube 102, 202, 302 of the present invention

Notwithstanding the forgoing, the dryer lint tube device 100, 200, 300 and the dryer lint tube 102, 202, 302 of the present invention can be of any suitable size and configuration as is known in the art without affecting the overall concept of the invention, provided that it accomplishes the above-stated objectives. One of ordinary skill in the art will appreciate that the size, configuration, and material of the dryer lint tube device 100, 200, 300 and the dryer lint tube 102, 202, 302 as shown in FIGS. 1-7 is for illustrative purposes only, and that many other sizes and shapes of the dryer lint tube device 100, 200, 300 and the dryer lint tube 102, 202, 302 are well within the scope of the present disclosure. Although the dimensions of the dryer lint tube device 100, 200, 300 and the dryer lint tube 102, 202, 302 are important design parameters for user convenience, the dryer lint tube device 100, 200, 300 and the dryer lint tube 102, 202, 302 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dryer lint tube device that connects a dryer exhaust vent from a dryer to a wall vent, the dryer lint tube device comprising:
a tube comprising a first end and a second end;
a first hose clamp; and
a second hose clamp, wherein the first hose clamp securely clamps the first end of the tube to an opening of the dryer exhaust vent, and further wherein the second hose clamp securely clamps the second end of the tube to the wall vent.

2. The dryer lint tube device of claim 1, wherein the tube is manufactured of a silicon.

3. The dryer lint tube device of claim 1, wherein the tube comprises alternate lengths of an accordion-style portion and a tubular-style portion.

4. The dryer lint tube device of claim 3, wherein the first end and the second end can be either the tubular-style portion or the accordion-style portion.

5. The dryer lint tube device of claim 1, wherein the tube comprises an accordion-style middle portion and a first and a second tubular-style opposing end portions.

6. The dryer lint tube device of claim 5, wherein the first tubular-style end portion is secured via the first hose clamp to the opening of the dryer exhaust vent.

7. The dryer lint tube device of claim 6, wherein the second tubular-style end portion is secured via the second hose clamp to the wall vent.

8. The dryer lint tube device of claim 7, wherein the first and the second tubular-style opposing end portions are integrated to the tube as one-piece.

9. The dryer lint tube device of claim 7, wherein the first and the second tubular-style opposing end portions are detachably secured to the tube.

10. The dryer lint tube device of claim 1, wherein the tube comprises an accordion-style portion without any tubular-style portions or tubular-style end portions.

11. A dryer lint tube device that connects a dryer exhaust vent from a dryer to a wall vent, the dryer lint tube device comprising:
a silicon tube comprising a first end and a second end, wherein the silicon tube comprises alternate lengths of an accordion-style portion and a tubular-style portion, and further wherein the first end and the second end can be either tubular-style or accordion-style portions;
a first hose clamp; and
a second hose clamp, wherein the first hose clamp securely clamps the first end of the silicon tube to an opening of the dryer exhaust vent, and further wherein the second hose clamp securely clamps the second end of the silicon tube to the wall vent.

12. The dryer lint tube device of claim 11, wherein the first and the second hose clamp comprises a round, flat, single-gear band.

13. The dryer lint tube device of claim 12, wherein the round, flat, single-gear band is circular in shape to secure around the first end and the second end of the silicon tube.

14. The dryer lint tube device of claim 13, wherein a diameter of the round, flat, single-gear band increases or decreases as a large end component rotates in a clockwise or in a counterclockwise direction within a screw gauge.

15. The dryer lint tube device of claim 14, wherein the round, flat, single-gear band comprises a plurality of slots that are configured to interact with the screw gauge to tighten or loosen the first and the second hose clamp.

16. The dryer lint tube device of claim 11, wherein the first and the second hose clamp is manufactured from a combination of steel or iron.

17. The dryer lint tube device of claim 11, wherein the first and the second hose clamp is manufactured from anhydrous ammonia that is cadmium plated to prevent rust and corrosion.

18. A method for connecting a dryer exhaust vent from a dryer to a wall vent using a dryer lint tube device comprising the steps of:
selecting a desired length of a tube comprising a first end and a second end;
securely fitting the first end of the tube onto the dryer exhaust vent; and
securely fitting the second end of the tube onto the wall vent, thereby connecting the dryer exhaust vent and the wall vent.

19. The method of claim 18, wherein the tube comprises alternate lengths of accordion-style and tubular-style portions.

20. The method of claim 18 further comprising a step of using one twist on hose clamp at both the first end and the second end to securely fit the tube onto the dryer exhaust vent and the wall vent, thereby preventing lint and debris from escaping.
